(19) United States
(12) Patent Application Publication
(10) Pub. No.: US 2007/0002770 A1
(43) Pub. Date: Jan. 4, 2007

(54) Mechanism to load balance traffic in an ethernet network

(75) Inventors: Ronald van Haalen, Nijmegen (NL); Arjan de Heer, Hengelo (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/171,034

(22) Filed: Jun. 30, 2005

(51) Int. Cl. H04L 12/28

(52) U.S. Cl. 370/256

(57) ABSTRACT

A new routing scheme for Ethernet that is based on load balancing is provided. Some advantages of load balancing are that it is robust to dynamic traffic demands, requires minimal over-provisioning, is simple, static, and requires only bandwidth profile associated with SLAs at the ingress and egress links. This scheme is applied to Ethernet in exemplary embodiments by load balancing traffic on different spanning trees so that these advantages are maintained. In addition, exemplary embodiments perform better than MLB, including a considerable reduction in delay.

### FIELD OF THE INVENTION

The present invention relates generally to the field of data networking and, in particular, relates to load balancing in Ethernet networks.

### BACKGROUND OF THE INVENTION

Ethernet is successfully expanding from small LANs into MANs and WANs. Ethernet service is being sold on a regional, national, and international scale. The revenue generated from this trend is expected to increase by a multiple of factors in the coming years. The main reasons behind its rapid acceptance are clearly its simplicity and low costs.

Ethernet services available today can be classified into two main categories: line and LAN. The Ethernet line services provide point-to-point connectivity and have a lot in common with the frame relay and leased line approach. For a point-to-point service, the provider can simply reserve network resources based on the agreed service levels for that connection. Ethernet LAN services, on the other hand, provide multipoint connectivity and are most cost-effective, but also far more complex. Due to the multi-point nature and uncertainty in the actual traffic flow between the multiple connection points, it is extremely difficult to provision the network to meet all traffic demand matrices without wasting network resources. Dynamic adjustments to routing or provisioning require signaling and management support adding to the complexity and costs. The challenge faced by the provider is to allocate resources such that both current and future traffic matrices can be supported, given unpredictable traffic, while minimizing over-provisioning and complexity.

### SUMMARY

Various deficiencies of the prior art are addressed by various exemplary embodiments of the present invention of a mechanism to load balance traffic in an Ethernet network.

One embodiment is a process for load balancing traffic in Ethernet networks that includes creating a plurality of spanning trees, mapping at least one virtual local area network (VLAN) onto each spanning tree, and an ingress node that distributes incoming traffic over all of the spanning trees.

Another embodiment is an apparatus for load balancing in Ethernet networks that includes a spanning tree component, a mapper, and an ingress node. The spanning tree component creates a plurality of spanning trees. The mapper maps at least one virtual local area network (VLAN) onto each spanning tree. The ingress node distributes incoming traffic over all of the spanning trees in a manner tending to evenly distribute traffic over an Ethernet network.

### BRIEF DESCRIPTION OF THE DRAWINGS

The teachings of the present invention can be readily understood by considering the following detailed description in conjunction with the accompanying drawings, in which:

FIG. 1 shows an exemplary network;

FIG. 2 shows a possible spanning tree for the network of FIG. 1;

FIG. 3 shows the blocked links for the different possible spanning trees of FIG. 1;

FIG. 4 shows how a conventional valiant load balancing (VLB) scheme and exemplary embodiments of an Ethernet Load Balancing (ELB) scheme route packets over an exemplary network;

FIG. 5 shows an overview of the possible positions of source S, destination D, and intermediate node I relative to each other;

FIG. 6 is a high level block diagram showing a computer. To facilitate understanding, identical reference numerals have been used, where possible, to designate identical elements that are common to the figures.

### DETAILED DESCRIPTION OF THE INVENTION

The invention will be primarily described within the general context of embodiments of a mechanism to load balance traffic in an Ethernet network, however, those skilled in the art and informed by the teachings herein will realize that the invention is applicable generally to load balancing in many different kinds of networks in the present and in the future, not only Ethernet, IP over optical, or Ethernet over MPLS, but also even more generic Ethernet over foo, and in general foo over foo.

Ethernet's move into metropolitan (MANs) and wide area networks (WANs) is driving a rapidly growing market opportunity. Current Ethernet services come in two basic flavors, namely Ethernet line and local area network (LAN) providing point-to-point and multipoint connectivity, respectively. The LAN services, though more cost-effective in nature, are lagging behind in deployments due to associated quality of service (QoS) and bandwidth provisioning issues. The Ethernet service provider needs to provision the network to meet current and future traffic demands where traffic is unpredictable and bursty with the goal of minimizing over-provisioning and complexity. To add to the challenge, Ethernet forwarding is based on simple self-learning and relies on spanning tree routing.

To address these challenges and others, exemplary embodiments include an Ethernet-specific load balanced routing mechanism that is robust to dynamic traffic demands, requires minimal over-provisioning, is simple, static, and requires only bandwidth profile associated with service level agreements (SLAs) at the ingress and egress links. Furthermore, exemplary embodiments do not require full mesh connectivity and have improved performance over traditional approaches.

Ethernet bridges are used to interconnect Ethernet LAN segments in order to form one bridged LAN network (BLN). There is a need for a bridge that interconnects LAN segments in such a way that, from a station connected to a BLN, all other stations connected to this BLN are reachable, as if they were connected to the same LAN.

It is desirable for bridges to be interconnected via a loop free topology. To make sure that bridges are interconnected via a loop free topology, the bridges may run a spanning tree protocol (STP) (e.g., IEEE 802.1D). Such a protocol determines, for each port of a bridge, whether the port is blocking (i.e., no traffic is accepted or sent via this port) or forwarding (i.e., traffic may be sent and received via this port). By blocking ports to links that create a loop, the topology is guaranteed to be loop free.

Besides making sure the topology is loop free, the STP also provides an alternative topology in case of a link failure. If a link fails in the network, this leads to loss of connectivity. If there is another possible topology that restores connectivity, the STP reconfigures to a connected topology again.

STP entities in different bridges communicate using bridge protocol data units (BPDUs). BPDUs are regular Ethernet frames with a special destination address.

For each packet a bridge receives on a port, the bridge associates the source address (SA) of the packet to the receiving port. This is called learning. Furthermore, the bridge checks whether the destination address (DA) of the frame has been previously associated to another port. If so, the packet is forwarded via that port (if the port is not blocked). If the DA is not associated with any port, the frame is forwarded via all forwarding ports. The latter is called flooding. Note that the frame is not forwarded via a blocked port, nor on the port the packet was received on.

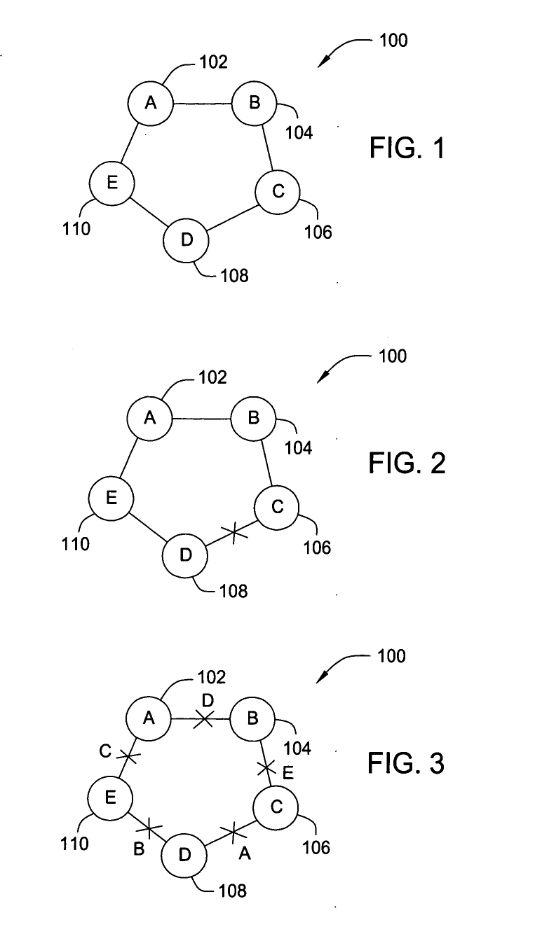

FIG. 1 shows an exemplary network 100. This example is a ring, but exemplary embodiments work with any network topology. In this example, network 100 has nodes A 102, B 104, C 106, D 108, and E 110.

FIG. 2 shows a possible spanning tree for the network 100 of FIG. 1. If A 102 sends many messages to D 108 and there is no other traffic in the network 100, then links A-E-D are the only ones used and could, therefore, become congested, while the other links still have enough capacity. Also, link C-D is blocked and not used at all, thus wasting bandwidth.

Conventionally, it is possible to use multiple spanning trees within a network. One conventional system creates a spanning tree per node. The node is the root bridge of that spanning tree. Whenever information needs to be sent from a certain node, the spanning tree of that node can be used.

FIG. 3 shows the blocked links for the different possible spanning trees. With one spanning tree with root node A, the major disadvantage is that link C-D cannot be used, but in FIG. 3 all links can be used. FIG. 3 shows that for traffic from A-D, still the link A-E-D (using tree A) is used. As a result, this could still cause congestion on these links, while the rest of the network could still have enough capacity.

In general, exemplary embodiments do not send packets from a certain source out on the same spanning tree every time, but rather sends them out on different spanning trees, which leads to packets taking different paths through the network.

The exemplary network 100 shown in FIG. 3 has all possible spanning trees per node, but, of course, any number and kind of spanning trees can be used. Considering network 100, packets from A could be sent out in a round-robin way, for example, on spanning trees A, B, C, D, E. This would lead to the packets taking route A-E-D for spanning trees D, E, and A and taking route A-B-C-D for spanning trees B and C.

One exemplary embodiment uses different virtual LAN (VLAN) IDs for different trees in IEEE 802.1Q. Packets with different VLAN IDs use different spanning trees.

One exemplary embodiment is a process. Multiple spanning trees are created in the network, assigning one or more VLAN IDs to each spanning tree. One possible way to create multiple spanning trees is by taking each node as the root and calculating the spanning tree. This creates n spanning trees in a network of n nodes. Packets are sent out with different VLAN IDs, resulting in them following different paths in the network. One possible way to do this is round robin for all used VLAN IDs. In order to prevent reordering within flows (e.g., defined by a specific source medium access control (MAC) address and destination MAC address combination), packets from the same flows are sent on the same VLAN, in one embodiment, thus using the same spanning tree. As a result, no reordering occurs within the flows, but different flows from the same source can still follow different paths. In one embodiment, link aggregation is used to send packets out on different links at the source.

In one exemplary embodiment, packets from a source are not sent out on the same spanning tree every time, but packets from a source are sent out on different spanning trees, which leads to packets taking different paths through the network. By load balancing the traffic, the network is better able to handle dynamic traffic patterns.

Ethernet Services Deployment Scenarios

Two popular methods for delivering Ethernet services are by transporting Ethernet frames over multiprotocol label switching (MPLS) and by using the native Ethernet protocol. The Ethernet over MPLS approach is realized by defining provider edge (PE) nodes that are interconnected via a full mesh of MPLS tunnels transporting pseudo wires (PWs). At ingress of the network, the PE node forwards the Ethernet frame to the required egress PE node. In the native Ethernet approach, the network consists of Ethernet switches/bridges. Packet forwarding is based on self-learning of medium access control (MAC) addresses that relies on a loop free topology. Different services are separated by using virtual LANs (VLANs) inside the network.

One advantage of the Ethernet over MPLS approach is the improved scalability. Native Ethernet uses VLAN tags to separate different services. There are only 4096 VLANs available and a VLAN is associated with the same customer throughout the network. For MPLS, there are more than one million labels possible and they are associated with a customer on a per link basis. The provider backbone bridge (PBB) development in the IEEE addresses the scalability issue by basically encapsulating the Ethernet frame into a new frame and adding a new larger tag.

In Ethernet, the loop free topology is created by the STP, which is not well suited for traffic engineering. MPLS offers more sophisticated traffic engineering capabilities. Proposals are made to replace the Ethernet STP for a routing and signaling protocol to improve the traffic engineering options. Those skilled in the art and informed by the teachings herein will realize that embodiments of the invention remain applicable if STP is replaced. Exemplary embodiments include an algorithm that is an improvement for traffic engineering in Ethernet that can be applied with STP or with any future routing/signaling protocols. The algorithm can be applied to Ethernet over MPLS as well, but the performance is better using native Ethernet.

Ethernet over MPLS Networks

For Ethernet over MPLS networks, the service provider creates a full mesh of label switched path (LSP) tunnels between every pair of PEs; the traffic from specific service instances is transferred via these tunnels using a PW. In order to be able to handle all traffic matrices, the provider needs to dimension each tunnel to accommodate the maximum traffic allowed between the nodes. Especially when providing LAN services, this may lead to a lot of over-provisioning in the network, as the traffic matrix is unknown and may change rapidly. The capacity of the tunnel is assigned statically and does not adapt itself to the actual load. The valiant load balancing (VLB) mechanisms and its proven properties can be directly applied to the Ethernet over MPLS network.

In the Ethernet over MPLS scheme, Ethernet traffic is forwarded form the ingress PE to the egress PE directly; it is a one hop forwarding scheme. When applying VLB, a two hop forwarding scheme called MPLS load balancing (MLB) is used. The ingress traffic into a PE node is distributed to all other PE nodes. This distribution can be round robin independent of the destination of the frame. The PE's receiving this traffic forward it to the required egress PE. Suppose that the MPLS network has n nodes and that the total ingress bandwidth at each PE and the egress bandwidth are the same, say N. Then, the MLB scheme requires two MPLS tunnels between every pair of PE's with capacity N/n. In the normal MPLS configuration, the bandwidth required for each tunnel to be able to accommodate all possible traffic loads would be N. If the bandwidth is less, it is hard to guarantee that all traffic matrices can be served.

In VLB the traffic forwarded is not Ethernet, but Internet protocol (IP) and the tunnels between the PEs may be created using synchronous optical network (SONET). VLB has many advantages. First of all, the configurations of the tunnels and PWs can be easily derived form the SLAs of the provided services. In one example, the ingress/egress bandwidth at all nodes is the same as VLB, but it can be easily adapted for the scenario where it varies. Furthermore, VLB can handle all valid traffic matrices, i.e., the total ingress and egress bandwidth at a user network interface (UNI) does not exceed the agreed maxima. It has been proved that for these types of networks, such as configuration is the most optimal configuration with respect to the used bandwidth capacity. Another advantage is the inherent protection.

Switched Ethernet Networks

An alternative to Ethernet transport over MPLS is using traditional Ethernet switching, i.e., using a network consisting of Ethernet bridges. These Ethernet bridges can be connected using, for example, synchronous digital hierarchy (SDH)/SONET or directly optical/wavelength division multiplexing (WDM). Switched Ethernet, due to its inherent design needs to operate on a loop free topology or spanning tree. Loops in the topology are removed by blocking ports to links tat create loops. This is performed by the STP. Traffic then traverses over such a tree, which spans the entire Ethernet network. In times of a failure the ST dynamically reconfigures to an alternate tree, enabling initially blocked ports. The simplicity of the ST-based routing, as compared to routing protocols like intermediate system to intermediate system (IS-IS) or open shortest path first (OSPF), comes at the cost of wasted bandwidth, because of the blocked links. The multiple spanning trees concept overcomes the bandwidth wastage of a single spanning tree. Instead of creating a single spanning tree, multiple spanning trees are created that have different links blocked. In order to exploit the real potential of multiple spanning trees, a mechanism is needed to efficiently load balance the traffic onto the multiple trees. This not only minimizes the required bandwidth for the Ethernet network, but also minimizes congestion. A method to determine the spanning trees to create and the mapping of the traffic on these trees is needed. In one Ethernet shortest path (ESP) ST optimization (IEEE 802.1ao), the numbers of STs are equal to the number of nodes in the network. Each node is the root of an ST. This has the advantage that the spanning trees to be created are known, as is the mapping of customer traffic on these trees.

Because of the deterministic bandwidth requirements of VLB, it would be attractive to apply a similar scheme to Ethernet. However, because of the forwarding mechanism in Ethernet, it is not trivial to implement a VLB scheme. As the switching nodes between the edge nodes are Ethernet switches, these nodes forward the frame towards the destination. One cannot force a frame to travel to the destination via a specified intermediate nodes, unless something special is done, such as having the ingress PE encapsulate the frame with the address of the intermediate PE and having this intermediate PE decapsulate the frame and forward it to the destination.

In order to overcome this problem, exemplary embodiments include a modified VLB scheme called Ethernet Load Balancing (ELB). ELB has a better performance than MLB.

Ethernet Load Balancing

Exemplary embodiments include a load balanced, spanning tree based routing scheme for Ethernet networks. Every node is the root of a spanning tree. Such a tree provides the shortest paths from the root of the tree to every other node in the network. There is at least one VLAN mapped onto each tree. Each ingress node distributes the incoming customer/access-network traffic over all the multiple spanning trees. This distribution can be round robin independent of the destination of the frame. A frame is distributed on a specific tree by classifying the frame into a VLAN mapped on that tree. Normally, all Ethernet frames received on a port are classified into the same VLAN and are distributed over the same tree. As a consequence of the distribution of frames over VLANs the total traffic load is distributed evenly over the network.

In order to prove this, exemplary embodiments of the ELB scheme are compared with the conventional MLB scheme. The selection of an intermediate node in the MLB scheme is replaced by the selection of a spanning tree in exemplary embodiments of the ELB scheme. The selection of the spanning tree merges the first and second hop of the MLB scheme as shown below. For the comparison between MLB and ELB, consider the same network consisting of nodes and links. For the MLB case, every node is a PE node and the full mesh is realized using the links between these nodes, e.g., if the full mesh would be realized using MPLS, this would imply that all nodes are both PE and P nodes. For the ELB scenario, all nodes are bridges that are interconnected via the links between them. Furthermore, assume the same route is used between any pair of nodes in the MLB and ELB case. In other words, a tunnel/PW from node A to node B fits on the spanning with node A as the root.

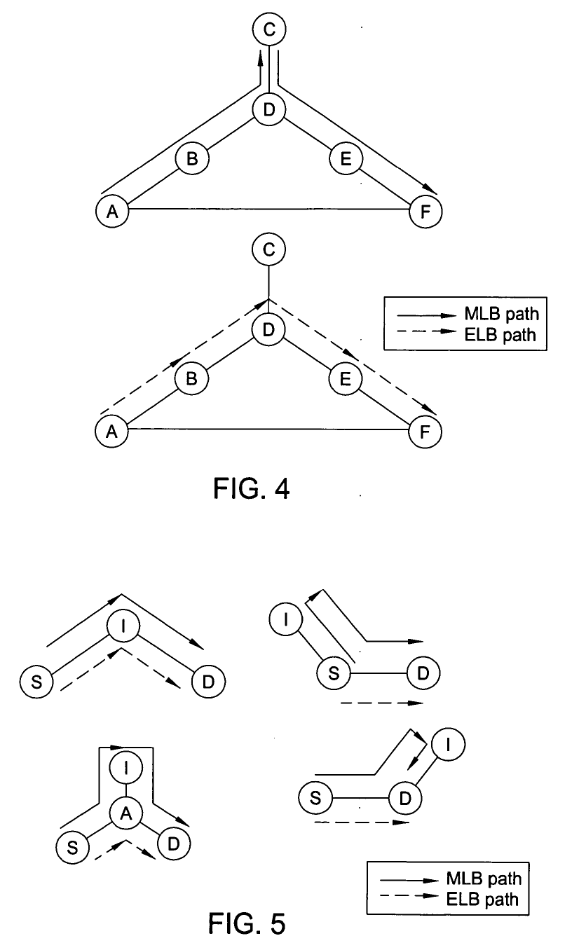

FIG. 4 shows how the conventional MLB scheme and exemplary embodiments of the ELB scheme route packets over an exemplary network. Suppose there is a frame that needs to be sent from source node A to destination node F. In the MLB scheme, node A selects an intermediate node, say node C. Because MLB works with a full mesh, the packet can be sent on the direct link between A and C. From C, the frame is forwarded directly to F. The B, D, and E nodes only act as P routers to create the tunnel between A and C and between C and F. In the ELB scheme, node A selects a spanning tree to send the frame on. This spanning tree is the one with node C as root (indicated with bold lines). The frame is forwarded over that tree towards F. However, the frame is not going through C and, more specifically, the detour D-C-D is avoided. In general, the path taken in the ELB approach is always shorter than in the MLB approach.

FIG. 5 shows an overview of the possible positions of source S, destination D, and intermediate node I relative to each other. A line between two nodes denotes that there is a path between these two nodes. Only the paths with significance for the S, D, and I nodes are drawn here and not the complete trees. The arrows denote the MLB and ELB paths, where switching only occurs at the arrowheads. The MLB path is always the same or longer than the ELB path. This is because the selection of the spanning trees with root I can be considered equivalent to selecting intermediate node I in the MLB scheme. If the ELB scheme and the MLB scheme were completely equivalent, the frame would first go to root I and from there to destination D. However, because the frame is forwarded by standard Ethernet rules over the spanning tree, the frame takes the direct path to F.

One of the consequences of a shorter path in ELB is bandwidth savings, which means that potentially more traffic fits on an ELB network than on a MLB network. Furthermore, the propagation delay is less. One of the advantages of MLB is that packets are only switched at the intermediate node, while ELB packets are switched at every node they traverse. Packets can be queued at every switching node. With simulations, the lower delay of ELB compared to MLB was verified and an indication of the amount of gain achieved with ELB was obtained.

Another advantage of ELB is that Ethernet supports multicast efficiently. In ELB, a frame may be replicated at any node in the network and will only be replicated if the routes to the destinations diverge. In MLB, on the other hand, the intermediate node replicates the frame, even if the frames follow for a large part the same path to the destination nodes.

For both load balancing schemes, the round robin distribution of Ethernet frames may introduce reordering. In one embodiment, a buffer at the egress node restores the original order. In an alternative embodiment, instead of using round robin distribution, a hash function over, for example, the source and/or destination address are used to determine the intermediate node or spanning tree. Such a function is already used in Ethernet link aggregation.

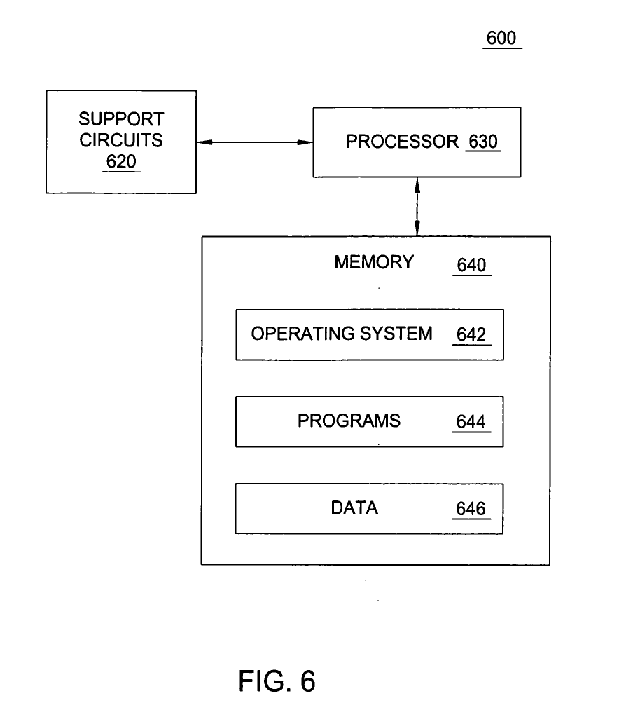

FIG. 6 is a high level block diagram showing a computer. The computer 600 may be employed to implement embodiments of the present invention. The computer 600 comprises a processor 630 as well as memory 640 for storing various programs 644 and data 646. The memory 640 may also store an operating system 642 supporting the programs 644.

The processor 630 cooperates with conventional support circuitry such as power supplies, clock circuits, cache memory and the like as well as circuits that assist in executing the software routines stored in the memory 640. As such, it is contemplated that some of the steps discussed herein as software methods may be implemented within hardware, for example, as circuitry that cooperates with the processor 630 to perform various method steps. The computer 600 also contains input/output (I/O) circuitry that forms an interface between the various functional elements communicating with the computer 600.

Although the computer 600 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided: Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A process for load balancing traffic in Ethernet networks, comprising:
creating a plurality of spanning trees;
mapping at least one virtual local area network (VLAN) onto each spanning tree; and
distributing, by an ingress node, incoming traffic over all of the spanning trees.

2. The process of claim 1, wherein at least a portion of the nodes in an Ethernet network are roots of at least one spanning tree.

3. The process of claim 1, wherein every node in an Ethernet network is the root of at least one spanning tree.

4. The process of claim 1, wherein each node is a bridge.

5. The process of claim 1, wherein distribution of traffic is round-robin for all spanning trees.

6. The process of claim 1, wherein packets with different VLAN IDs use different spanning trees.

7. The process of claim 1, further comprising:
sending packets from a same flow on a same VLAN to prevent reordering within the same flow.

8. The process of claim 1, wherein the network is an optical network with SONET/SDH and Ethernet capabilities.

9. An apparatus for load balancing in Ethernet networks, comprising:
a spanning tree component to create a plurality of spanning trees;
a mapper to map at least one virtual local area network (VLAN) onto each spanning tree; and
an ingress node to distribute incoming traffic over all of the spanning trees in a manner tending to evenly distribute traffic over an Ethernet network.

10. The apparatus of claim 9, wherein at least a portion of the nodes in an Ethernet network are roots of at least one spanning tree.

11. The apparatus of claim 9, wherein every node in an Ethernet network are roots of at least one spanning tree.

12. The apparatus of claim 9, wherein each node is a bridge.

13. The apparatus of claim 9, wherein distribution of traffic is round-robin for all spanning trees.

14. The apparatus of claim 9, wherein packets with different VLAN IDs use different spanning trees.

15. The apparatus of claim 9, wherein the ingress node sends packets from a same flow on a same VLAN to prevent reordering within the same flow.

16. The apparatus of claim 9, wherein the network is an optical network with SONET/SDH and Ethernet capabilities.
